(19) United States
(12) Patent Application Publication
(10) Pub. No.: US 2015/0324822 A1
(43) Pub. Date: Nov. 12, 2015

(54) PREDICTING TRANSIENT POPULATION BASED ON PAYMENT CARD USAGE

(71) Applicant: MASTERCARD INTERNATIONAL INCORPORATED, Purchase, NY (US)

(72) Inventors: Kenny Unser, Fairfield, CT (US); Serge Bernard, Danbury, CT (US); Nikhil Malgatti, Stamford, CT (US)

(73) Assignee: MASTERCARD INTERNATIONAL INCORPORATED, Purchase, NY (US)

(21) Appl. No.: 14/270,489

(22) Filed: May 6, 2014

(51) Int. Cl. G06Q 30/02; G06Q 40/00

(52) U.S. Cl. CPC G06Q 30/0205; G06Q 40/12

(57) ABSTRACT

A system and a method for predicting the transient population of a geographic location or region using point of sale transaction data are disclosed. Historical purchase data is used to develop logic for predicting a transient population at any given time, or predicting or determining the present transient population. The logic can be tested against transaction data to qualify its accuracy. Statistical techniques are used to develop the logic with a sample of payment cardholders during an analytical phase. The logic can be applied to a broader universe of cardholders to ascertain a higher level of confidence that can be assigned to the prediction.

### BACKGROUND OF THE DISCLOSURE

1. Field of the Disclosure

The present disclosure relates to the use of payment card purchase information for prediction purposes. More particularly, the present disclosure relates to predicting or estimating a transient population based on payment card usage.

2. Description of the Related Art

The availability of payment card transaction data provides unique opportunities to service a customer using a payment card. It provides opportunities to determine when and where customers use their payment cards to make purchases. This information is also of value to card issuers, as noted below.

A possible benefit is that if the location of use of a payment card is known, targeted advertising for that location can be sent to the users of the payment cards. Thus, the users are informed of goods or services that are available at that location, and the payment card issuer receives the possible benefit of additional transactions being conducted by the payment card user.

In a broader sense, the location of large numbers of payment card users may be indicative of temporary travel, seasonal travel, or a more permanent change in location.

Thus, there exists a need for a system and a method for predicting or estimating, with as much certainty as possible, the locations of a large number of users of payment cards, and in particular, changes in the locations of the users. Currently, there is no way to know or predict the location of a payment card user.

### SUMMARY OF THE DISCLOSURE

The present disclosure provides a system and a method for predicting changes in population of a particular location or region, based on use of payment cards.

The present disclosure also provides that the system uses historical purchase data to develop logic for predicting the transient population at a selected time in the future or at the present time.

The present disclosure further provides that the logic can be tested against transaction data to determine a confidence level of the prediction.

The present disclosure still further provides that the logic can be retested against transaction data and insights to improve the confidence level of the prediction.

When transient population for a location is predicted, a given geographic location or region can better estimate what resources are required to service that population. As used herein, a geographic location can be a town, a zip code, a city, a county, a selected portion of a state, or an ad hoc combination of any of the above in which the transient population varies with scheduled or isolated events. Estimates of required roads, recreational facilities, hotels, motels, schools, required workers, and general impact on the location can, thus, be made. Further, predicting the size of transient populations and the times at which the transient populations are present improves the accuracy of estimates of tax revenue that will be received. This is a great benefit to local planning efforts.

The present disclosure yet further provides a computer readable non-transitory storage medium that stores instructions of a computer program, which when executed by a computer system, results in performance of steps of the method for predicting or estimating the transient population at a given location based on payment card transactions.

### BRIEF DESCRIPTION OF THE DRAWINGS

FIG. 1 is a block diagram of a portion of a payment card system used in accordance with the present disclosure

FIG. 2 is a flow chart of a method according to the present disclosure.

FIG. 3 is a logic flow used in the flow chart of FIG. 2 to predict transient population.

A component or a feature that is common to more than one drawing is indicated with the same reference number in each of the drawings.

### DESCRIPTION OF THE EMBODIMENTS

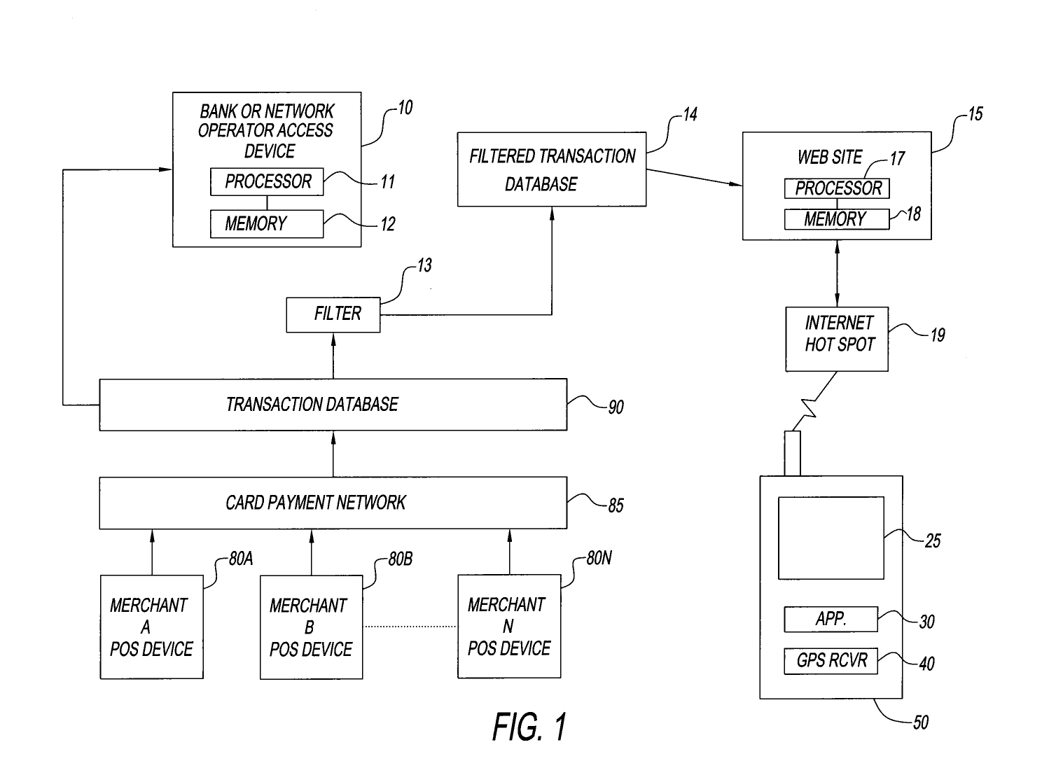

Referring to the drawings and, in particular, FIG. 1, a portion of a payment card system used in accordance with the present disclosure is shown. Each merchant that accepts a payment card has on their premises at least one card swiping machine or point of sale device 80, of a type well known in the art, for initiating customer transactions. These point of sale devices 80A, 80B, . . . 80N, generally have a keyboard data pad for entering data when a card's magnetic coding becomes difficult to read, or for the purpose of entering card data resulting from telephone calls during which the customer provides card data by telephone.

Point of sale devices 80A, 80B, . . . 80N are connected by a suitable card payment network 85 to a transaction database 90 associated with or within network 85 that stores information concerning the transactions. An example of such a network 85 is BankNet operated by MasterCard International Incorporated. BankNet is a four party payment network that connects a card issuer, a card holder, merchants, and an acquiring bank, as is well known in the art. In another embodiment, network 85 can be a three party system. In any such embodiment, POS devices 80 do not have direct access to transaction database 90. It is the operator of network 85 that can access transaction database 90.

Information in database 90 can be accessed by a bank or network operator access device 10, such as a computer having a processor 11 and a memory 12. Users of device 10 can be employees of the bank or a payment network operator who are doing research or development work, such as running inquiries, to improve the logic used to estimate the transient population, or are investigating the likely accuracy of the existing logic, in providing an estimate of the transient population.

Transaction records stored in transaction database 90 contain information that is highly confidential and must be maintained confidential to prevent fraud and identity theft. The transaction records stored in transaction database 90 can be anonymized by using a filter 13 that removes confidential information, but retains records concerning all of the other transaction related details discussed above, preferably in real time. Anonymized data is generally necessary for marketing applications. The filtered data is stored in a filtered transaction database 14 that can be accessed as described below. The data in the filtered transaction database 14 can be stored in any type of memory including a hard drive, a flash memory, on a CD, in a RAM, or any other suitable memory.

The following example of an approach to accessing the data involves a mobile telephone. However, it is understood that that there are various other approaches, technologies and pathways that can be used, including direct access by employees of the card issuing bank or a payment network operator.

A mobile telephone 50 having a display 25 can have a series of applications or applets thereon including an applet or application program (hereinafter an application) 30 for use with the embodiment described herein. Mobile telephone 50 can also be equipped with a GPS receiver 40 so that its position is always known.

Mobile telephone 50 can be used to access a website 15 on the Internet, via an Internet connected Wi-Fi hot spot 19 (or by any telephone network, such as a 3G or 4G system, on which mobile telephone 50 communicates), by using application 30. Web site 15 is linked to database 14 so that authorized users of website 15 can have access to the data contained therein. These users can be employees of the bank or a network operator who is making inquiries as described above with bank or operator access device 10.

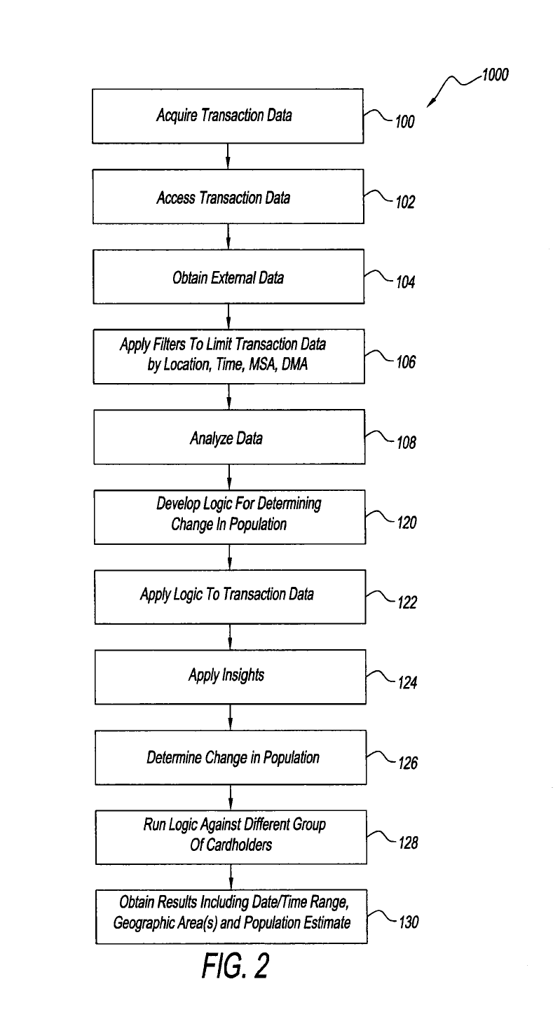

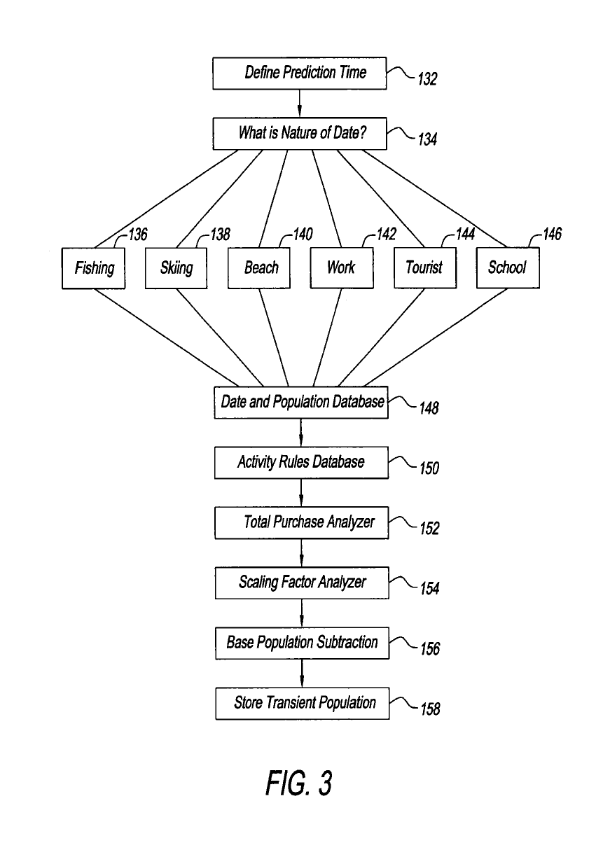

Web site 15 has a processor 17 for assembling data from filtered transaction database 14 for responding to inquiries, as more fully discussed above with respect to FIGS. 2 and 3. A memory 18 associated with web site 15 having a non-transitory computer readable medium, stores computer readable instructions for use by processor 17 in implementing the operation of the disclosed embodiment.

Referring to FIG. 2, the method of the present disclosure is generally referenced by reference numeral 1000. At 100, transaction data is acquired or accessed. Such data can be obtained using the system described with respect to FIG. 1, or from other systems that are used to store such data.

Generally, the acquired transaction data is point of sale data since such data is most representative of the actual location of a user. However, if it is possible to verify that, for example, a home computer was used to make a purchase, for goods to be delivered at a future date at another location, that purchase is a high confidence indicator that the user who made the purchase will be at that other location on that future date.

Relevant transaction data usually obtained for a payment card transaction includes acquirer identifier/card accepter identifier (the combination of which uniquely defines the merchant); merchant address (i.e., full address and or GPS data); merchant category code (also known as card acceptor business code) that is an indication of the type of business the merchant is involved in (for example, a gas station); local transaction date and time; cardholder base currency (i.e., U.S. Dollars, Euro, Yen, and the like); the transaction environment or method used to conduct the transaction (point of sale by card swipe, telephone sale or web site sale); product specific data such as SKU line item data; and cost of the transaction or transactional amount.

Purchase data can be filtered by at least one of time, metropolitan statistical area (MSA) and designated market area (DMA). The transaction data used for testing accuracy of prediction can be future transaction data, or data from a larger group than the one used for acquiring the original data.

Other relevant information is customer information including a customer account identifier that would be anonymized (or at least filtered to remove customer account identifiers), customer geography (that would generally be known or be modeled in some way), the type of customer (for example, consumer or business), and customer demographics.

With respect to the merchant, external data, such as geographic grouping, MSA and DMA, can be obtained.

At 102, the acquired transaction data can be accessed to perform various functions as described below. One path for accessing the transaction data is described with respect to FIG. 1. However, transaction data can be accessed directly by the entity that customarily stores such transaction data, such as an operator of a payment card network used to settle payment card transactions.

At 104, various kinds of external data representative or associated with events or schedules of interest can be obtained. For example, external data can include event schedules for a specific geographical location or region. Specific time frames, such as fishing season, beach season, harvest season, tourist season, and school season, can be acquired. Weather information can be relevant to how many people change locations.

Weather information can include, for example, average daily temperature.

There can be validation data sets for a specific geographical location or region. These validation data sets can include estimates of the number of seasonal workers, the number of students at one or more schools, survey data, and the number of temporary or relief workers associated with a particular event, such as a natural disaster. Census data can be used to determine the usual residential population of a specific geographical location or region.

At 106, the stored transaction data is filtered based on various criteria. One criteria is time filtering. Time filtering can include filtering transactions with respect to event schedules, seasons as discussed above, weekday, weekend, day verses evening, holiday schedules, school schedules (college, high school, elementary school), or in any number of other ways, with respect to time.

Transactions or transaction data can also be sorted by other filters. Such filters can include local geographies and boundaries, as well as merchant geography groupings, such as by city, postal code, county, state and country. Other filters are MSA and DMA.

At 108, acquired data is analyzed. Merchant geographies groupings, such as city, postal code, county, state and country, can be used in the analysis. Statistical analysis tools, such as clustering, segmentation and ranking, can also be used. Nielsen DMA or MSA can be used in the analysis.

At 120, logic is developed for determining the size of transient populations. Stated differently, this is the change in population at a specific geographic location due to a schedule or due to events that occur. Seasonal categories of classification, such as employment seasons, ski season, fishing season, harvest season, winter-summer, summer, tourist season, beach season, school breaks, school seasons (fall semester, spring semester summer session, summer break and spring break), can be factored into the logic. Specific holidays, such as July 4^{th}, Labor Day, Thanksgiving and Christmas, can also be factored into the logic.

Cardholder level classifications can be used. For example, these classifications can include a time of day pattern that indicates where a cardholder transacts with merchants, the specific weeks each year during which a cardholder travels internationally to a particular destinations, specific weeks each year during which a cardholder travels domestically to a particular destination, and does the cardholder appear to have seasonal residences (for example snowbirds, with a northern residence in the summer and a southern residence in the winter).

Further cardholder level classifications can include a repeated migration pattern of ski bums, beach bums, fishermen, aid workers or traveling contractors.

General classifications can include popular travel weeks, popular lunch spots for commuters, indicators of residential spending (for example, spending for dry cleaning, drug store items, groceries, indicators of travel spending (for example purchases at souvenir shops), and purchases that identify logical time breaks and geography breaks. Additional general classifications include identifying geographies that see fluctuations in population, patterns related to specific triggers (such as natural disasters), weather patterns, and harvest seasons.

Based on these classifications, logic for predicting the transient population in a geographic location or region is developed. A process for utilizing historic transaction activity to predict current/future transient population is created. The process can include one or more algorithms. The data discussed above is analyzed with this logic.

At 122, the logic, that is developed based on the various classifications of the data, is applied to the transaction data. While good predictability of transient population can be achieved, certain insights can be applied to achieve greater accuracy.

At 124, insights from general experience, and those based on a particular geographic location or region, can be applied to assist in estimating the transient population. Some examples of such insights are:

1. During the summer salmon fishing season, the population of King Salmon, Ak. sees an influx of 25,000 seasonal residents.

2. During the school year, the population of Ithica, N.Y. sees an influx of almost 100,000 college students and associated seasonal workers.

3. Fort Lauderdale, Fla. has a snowbird population of 250,000 people.

4. During the peak of the British Petroleum oil spill cleanup efforts in 2010, there were approximately an additional 15,000 people in the Galveston, Tex. region.

Many additional insights and refinements to these insights mentioned above, can be used.

At 126, an estimate is made as to the change in population in a geographic location or region as a result of running the data against the logic developed at 122. When doing so, it is important to differentiate between unusual events that may cause a significant change in population, and those that are due to changes in the baseline. The data can be subject to analysis based on, for example, a minimum/maximum approach, or based on standard deviation. The goal is to differentiate normal behavior from what is a statistical aberration.

At 128, the logic (and possibly the insights) is run against historical data of a different group of cardholders. The different group of cardholders can be a larger group or universe of people (engaging in a larger universe of cardholder payment card transactions) who are conducting payment card transactions at the geographic location where an estimate of transient population is made. A transient population based on this additional or subsequent cardholder transaction data is compared to the estimate of transient population based on the more limited universe of data. Based on this subsequent or additional cardholder transaction data, an estimate is obtained of a level of confidence that can be assigned to the logic used to obtain the estimates of transient population. In doing such comparisons to a larger group of people, it is necessary to take into account the approximate size of the base population to determine a level of confidence. For example, in a large city, the effects of any one event may make only a small difference, as there can be dozens of possibly significant events that could each influence the data to some degree, during a particular time interval of interest. In a small city, with many fewer significant events in a time interval of interest, it is far more likely that an error in determining confidence level will result due to the occurrence of a significant event.

At 130, for a given date, in a given geographic location or region, an estimate of the population is produced. Estimates for multiple dates in a time range can also be obtained.

Referring to FIG. 3, one of the many possible logic flows for estimating the transient population at a geographic location or region is illustrated. At 132, the prediction date for when the transient population is to be estimated, is entered via a user interface, as described with respect to FIG. 1. Dates in the future can be entered. In a default situation, the current date is used to estimate the current transient population.

At 134, a determination is made as to the nature of the date defined at 132. For purposes of illustration, the nature of the date can be during: fishing season 136, ski season 138, beach season 140, a work season 142 (such as for example, harvesting), a tourist season 144, or a school season 146. In principle, other kinds of dates can be defined such as, for example, a local celebration date, or a holiday. A given date can fall into more than one of these categories. The exact nature of each day in a particular year can be specified by consulting a calendar for that year, as the date for holidays, such as Memorial Day, Labor Day, and Thanksgiving Day, will vary from year to year. At 148, a database of dates and historical population estimates for those dates are accessed. This database stores information defining the date or date range for seasons mentioned above, the various holiday dates, and the population that was previously estimated to be present in that location or region on those dates.

At 150, an activity rules database is accessed for rules for a particular seasons and for particular dates, and used to assist in estimating the transient population. For example, for work seasons where single individuals are generally present, it is assumed that all payment card transactions on a given payment card account originate with, and are representative of, one transient person. However, for fishing, skiing and beach seasons, which are more likely to have couple or family events, it can be assumed that each payment card transaction is representative of more than one transient individual being present at the location or in the region.

At 152, a total payment analyzer computes total payment activity for a date entered at 132, both in terms of total revenue and total number of transactions. Some transactions can be rated more highly as indicative of the presence of transient persons, such as payment card transactions for local hotels and motels. Other activity can be a bit more ambiguous, such as restaurant and diner transactions, that can be indicative of transient population, or of permanent residents simply enjoying a night out, such as on a Friday or Saturday evening. Appropriate weight factors can be assigned to all payment card activity to more accurately reflect the number of transient persons represented by that activity.

At 154, a scaling factor is applied to the total revenue represented by the payment card transactions. For example, in the case of a town that has only fishing activity in the summer, and virtually no transient activity during the winter months, payment card activity for the permanent residents during the winter months is correlated to a known winter population of 10,000 people. If during the peak of summer fishing season, the payment card revenue increases to 2.5 times larger than during the winter months, the total population of the town during fishing season is estimated to be 25,000 persons. However, a linear relationship is not a foregone conclusion. Experience shows that the transient populations spend more or less per person than the permanent residents spend during winter months. The scaling factors can be adjusted in accordance with actual experience. Such scaling factors are determined by making a comparison between data for the general population, and data for the population that has used a payment card to make a purchase. For example, it may be found that an adjustment is required because the population that has made payment card purchases is wealthier than the general population, or is different in some sense due to the demographics of who the purchasers are (by gender, age, spending frequency etc.).

Scaling can be accomplished by using a geographic area with a known population and summarizing spending activity.

Thus, the spending activity can be calibrated to the population count. In one embodiment, factors that can influence the relationship between spending activity and population count are determined and used for calibration. For example, in times of recession, all members of a given population, whether transient or not, may spend less.

At 156, the population of permanent residents, for example, 10,000 is subtracted from the estimated total population, for example 25,000, to arrive at an estimated transient population of 15,000. At 158, the difference, namely 15,000, is stored as the estimated number for the transient population on the selected date. In some embodiments, an adjustment can be made for changes in the number of permanent residents. For example, the population of a geographic area, such as a town, city or county can be experiencing a trend of year to year growth of five percent. Unless there is some reason for a departure from this trend, growth of five percent per year can be assumed.

It is understood that the present disclosure can be embodied in a computer readable non-transitory storage medium storing instructions of a computer program that when executed by a computer system results in performance of steps of the method described herein. Such storage media can include any of those mentioned in the description above.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A system for predicting a present or future transient population for a geographic location based on payment card transactions, comprising:
an electronic storage device having a database of the payment card transactions stored therein;
an access path for allowing access to data concerning the payment card transactions in the database, the data concerning the payment card transactions including when and where point of sale transactions have taken place; and
a processor for conducting a process to analyze the data concerning the payment card transactions, wherein the processor has programmed logic that provides an estimate of the transient population at a present or a selected future time in the geographic location by analyzing the payment card transactions in the database that occurred at a prior time at the geographic location, and wherein the transient population in the geographic location at the present or the selected future time is predicted.

2. The system of claim 1, wherein the processor predicts the transient population at the present time.

3. The system of claim 1, wherein the selected future time is a period of predetermined future time, and wherein the processor predicts the transient population during that period.

4. The system of claim 1, wherein the database includes data concerning payment card transactions of a universe of cardholders conducting transaction at the geographic location, and wherein the logic is applied to data concerning payment card transactions from a first group of cardholders in the universe of cardholders and subsequently to data concerning payment card transactions of a second group of cardholders in the universe of cardholders, to determine accuracy of estimation of the logic.

5. The system of claim 4, wherein the second group of cardholders is larger than the first group of cardholders.

6. The system of claim 1, wherein the data concerning the payment card transactions is analyzed by at least one criteria selected from the group consisting of time, metropolitan statistical area, and designated market area.

7. The system of claim 1, wherein the logic is configured to receive as input at least one date and to estimate transient population at that at least one date.

8. The system of claim 7, wherein the logic analyzes the data concerning the payment card transactions to determine whether the at least one date is in a season selected from the group consisting of a fishing season, a skiing season, a beach season, a work season, a tourist season, and a school season.

9. The system of claim 1, wherein the logic estimates the transient population by subtracting permanent resident population from total estimated population based on the number of payment card transactions or the total value of payment card transactions, in the geographic location.

10. The system of claim 1, further comprising using general insights as a factor in estimating the transient population at the present or the selected future time, wherein the general insights include historical data of payment card transactions in the database.

11. A method for predicting the present or future transient population of a geographic location based on payment card transactions, comprising:
storing data concerning the payment card transactions in an electronic storage device having a database;
accessing the data concerning the payment card transactions in the database, wherein the accessed data includes data of the time when and place where point of sale transactions took place; and
analyzing the accessed data with a processor in accordance with a programmed logic to derive an estimate of the transient population at a present or a selected future time in the geographic location by analyzing the payment card transactions in the database that occurred at a prior time, wherein the transient population in the geographic location at the present or the selected future time is predicted.

12. The method of claim 11, wherein the processor estimates the transient population at the present time.

13. The method of claim 11, wherein the database includes data concerning payment card transactions of a universe of cardholders conducting transactions at the geographic location, further comprising applying the logic to data concerning payment card transactions from a first group of cardholders in the universe of cardholders and subsequently to data concerning the payment card transactions from a second group of cardholders in the universe of cardholders, to determine accuracy of estimation of the logic.

14. The method of claim 13, wherein the second group of cardholders is larger than the first group of cardholders.

15. The method of claim 11, further comprising analyzing the data concerning the payment card transactions by at least one criteria selected from the group consisting of time, metropolitan statistical area, and designated market area.

16. The method of claim 11, further comprising:
receiving as input in the logic at least one date, and
estimating transient population at that at least one date.

17. The method of claim 16, further comprising analyzing the data concerning the payment card transactions to determine whether the at least one date is in a season, and wherein the season is selected from the group consisting of a fishing season, a skiing season, a beach season, a work season, a tourist season, and a school season.

18. The method of claim 11, wherein the logic estimates the transient population by subtracting permanent resident population from total estimated population, and wherein the estimate is based on the number of payment card transactions or total value of payment card transactions, in the geographic location.

19. The method of claim 11, further comprising using general insights as a factor in estimating the transient population at the present or the selected future time, wherein the general insights include historical data of payment card transactions in the database.

20. A computer readable non-transitory storage medium storing instructions of a computer program which when executed by a computer system results in performance of steps of a method for predicting transient population based on payment card transaction data, comprising:
storing in an electronic storage device having a database, data concerning payment card transactions;
accessing the data concerning the payment card transactions in the database, wherein the accessed data includes data on when and where point of sale transactions have taken place; and
analyzing the accessed data with a processor in accordance with a programmed logic therein to predict the present or future transient population at the present or selected future time, respectively, by analyzing the payment card transactions in the database that occurred at a prior time.
